(19) United States
(12) Patent Application Publication
(10) Pub. No.: US 2022/0386810 A1
(43) Pub. Date: Dec. 8, 2022

(54) GAS APPLIANCE WITH SELECTIVELY MOVEABLE BURNER UNIT

(71) Applicant: Ross Edward Noble, Austin, TX (US)

(72) Inventor: Ross Edward Noble, Austin, TX (US)

(21) Appl. No.: 17/340,524

(22) Filed: Jun. 7, 2021

(51) Int. Cl. A47J 37/07

(52) U.S. Cl. CPC A47J 37/074; A47J 37/0713

(57) ABSTRACT

Disclosed herein are gas appliance with rotatable burners, where the gas burner thereof is movable between a plurality of positions such as use, dump, and down. Use position is that of the gas appliance being capable of being used for its intended purpose (e.g., gas burner in its operating position), and in the case of a brazier, the gas burner is facing up. Dump (i.e., a non-use) position refers to a gas burner position which dumps solid fuel by gravity. Down (i.e., a non-use) position refers to a gas burner position (e.g., for a top fired (e.g., radiant) gas burner) where the gas burner is facing upside down. A transducer monitors rotary shaft angular position to enable gas flow only when the gas burner is in the use position. For embodiment configured with partially aerated gas burner and a solid fuel crib, upon dumping of solid fuel, the solid fuel falls into an ash pan to enable its reuse or safe disposal.

### FIELD OF THE DISCLOSURE

The disclosures made herein relate generally to gas appliances useful as a heat source and, more particularly, to gas appliances in the form of a cooking grill with a moveable (e.g., rotatable) burner unit.

### BACKGROUND

The practice and techniques of cooking over an open flame or the like is well-known. Such cooking is typically carried out using a tradition cooker that has a gas burner, a structure containing a volume of charcoal, wood pellets or other combustible solid fuel, or a combination thereof. In some instances, a traditional gas appliance cooker utilizes both a gas burner and a volume of solid fuel located above the gas burner. The solid fuel is generally contained within a solid fuel support structure such as, for example, a tray, crib (e.g., a basket) or the like. A flame from the gas burner may be used to ignite the above-located charcoal and/or may be used as a standalone heat source when such charcoal or other combustible solid fuel is not used or is fully depleted.

Traditional partially aerated gas burner cookers with solid fuel located above the gas burner cannot conveniently dump partially used solid fuel and/or ashes thereof for appliance cleaning or charcoal sequestration purposes. Because the gas burner is located below the solid fuel containment structure in a traditional partially aerated gas burner cooker, dumping of the solid fuel and/or ashes thereof presents the likelihood of fouling the gas burner (e.g., the aeration passage and/or flame port thereof). Similarly, top firing burners such as a radiant burner, when turned off, are vulnerable to flame port fouling by falling crumbs, debris, and liquids.

Therefore, a gas appliance having a gas burner arrangement that mitigates, if not eliminates, the likeliness of fouling thereof from falling fuel particulate, ash, and the like to overcome drawbacks associated with traditional fixed-position gas burner arrangements would be advantageous, desirable and useful.

### SUMMARY OF THE DISCLOSURE

Embodiments of the disclosures made herein are directed to gas appliances configured to mitigate, if not eliminate, the likeliness of aeration passage fouling and/or flame port fouling resulting from fuel particulate, ash, and the like falling into contact therewith from above. More specifically, embodiments of the disclosures made herein are directed to a burner unit arrangement that provides for joint rotation (e.g., tilting by up to about 180 degrees) of the gas burner from a use position (e.g., vertically upright) to a non-use position (e.g., tilted by at least about 90 degrees from the use position to about 180 degrees from the use position). In embodiments where solid fuel is used, unburned solid fuel and/or ashes thereof contained by a solid fuel support structure attached to the burner unit above the gas burner are dumped under gravity when the burner unit is moved from the use position to the non-use position. In this manner, unburned solid fuel and/or ashes are not dumped onto the gas burner. In preferred embodiments, the solid fuel support structure is positioned directly over the gas burner when the burner unit is in the use position and is located to the side of or below the gas burner when the burner unit is in the non-use position. In view of the foregoing aspects of a gas appliance in accordance with the disclosures made herein, such a gas appliance advantageously overcomes shortcomings associated with conventional gas appliances by mitigating, if not eliminating, the likeliness of aeration passage fouling and/or flame port fouling.

In the case of a traditional partially aerated burner, both the gas burner and the solid fuel support structure above the gas burner may be structured to be jointly rotated from the use position to the dump position. Dumping of solid fuel (e.g., live charcoals) by gravity allows the solid fuel to be collected, extinguished (e.g., via suffocation) and then subsequently re-used. Recovery and re-use of solid fuel, such as charcoal, wood or wood pellets, is beneficial to a user of a gas appliance. Rotating a top fired burner from the use position fully or at least partially to the non-use position extends the bandwidth of such a gas appliance to include easy cleaning of a gas appliance having a top fired gas burner and to also prevent the top fired gas burner of such a gas appliance from becoming fouled when burner is off.

In one or more embodiments of the disclosures made herein, a gas appliance comprises an appliance housing and a burner unit located at least partially within an interior space of the appliance housing. The burner unit includes a gas burner and a gas burner body. The burner unit is movably attached to the appliance housing for enabling the burner unit to be selectively moved between a use position thereof and a non-use position thereof. The gas burner is integral with the gas burner body whereby the gas burner remains in a fixed orientation relative to the gas burner body when the burner unit is moved between the use position and the non-use position.

In one or more embodiments of the disclosures made herein, a gas appliance comprises an appliance housing having an interior space and a burner unit located at least partially within the interior space of the appliance housing. The burner unit includes a gas burner and a solid fuel support structure. The burner unit is movably attached to the appliance housing for enabling the burner unit to be selectively moved between a use position thereof and a dump position thereof. The gas burner and the solid fuel support structure are integral with the burner unit whereby the solid fuel support structure remains in a fixed orientation relative to the gas burner when the burner unit is moved between the use position and the dump position.

In one or more embodiments of the disclosures made herein, a cooking grill comprises a grill body having one or more walls defining an interior space of the grill body and a burner unit located within the interior space of the grill body. The burner unit is rotatably attached to the grill body for enabling the burner unit to be selectively rotated about a rotation axis of the burner unit between a use position thereof and a dump position thereof. The burner unit includes a partially aerated gas burner and a solid fuel support structure. The partially aerated gas burner and the solid fuel support structure are integral with the burner unit whereby the solid fuel support structure remains in a fixed orientation relative to the partially aerated gas burner when the burner unit is moved between the use position and the dump position. The gas burner is located above the rotation axis when the burner unit is in the use position and the solid fuel support structure is located above the gas burner when the burner unit is in the use position.

In one or more embodiments of the disclosures made herein, the gas burner is one of a radiant burner and a partially aerated gas burner.

In one or more embodiments of the disclosures made herein, when the burner unit is in the use position, a top face of the burner unit faces an opening within a top face of the appliance housing through which the interior space is accessible and when the burner unit is in the non-use (e.g., dump) position, the top face of the burner unit faces away from the opening within the top face of the appliance housing.

In one or more embodiments of the disclosures made herein, the burner unit is rotatably attached to the appliance housing for being rotated about a rotation axis of the burner unit.

In one or more embodiments of the disclosures made herein, the gas burner is located above the rotation axis when the burner unit is in use position.

In one or more embodiments of the disclosures made herein, the gas burner is a partially aerated gas burner, the burner unit further includes a solid fuel support structure and the solid fuel support structure is integral with the burner unit to enable the solid fuel support structure to remain in a fixed orientation relative to the gas burner when the burner unit is moved between the use position and the non-use position.

In one or more embodiments of the disclosures made herein, the solid fuel support structure is a fuel crib.

In one or more embodiments of the disclosures made herein, when the burner unit is in the use position, the gas burner is located above the rotation axis and the solid fuel support structure is located above the gas burner.

In one or more embodiments of the disclosures made herein, a top face of the burner unit faces an opening within a top face of the appliance housing through which the interior space is accessible when the burner unit is in the use position and the top face of the burner unit faces away from the opening within the top face of the appliance housing when the burner unit is in the non-use position.

In one or more embodiments of the disclosures made herein, the gas appliance further comprises a gas flow-control valve operably coupled to the gas burner and an actuation device operably coupled to the gas flow-control valve, the gas flow-control valve enables gas flow to the gas burner to be at least one of selectively enabled and selectively disabled, the actuation device causes the gas flow-control valve to at least one of enable gas flow to the gas burner when in a first state of operability and disable gas flow to the gas burner when in a second state of operability and the first state of operability corresponds to the burner unit being in the use position and the second state of operability corresponds to the burner unit being moved to a position away from the use position.

In one or more embodiments of the disclosures made herein, the gas appliance further comprises a burner unit movement body attached to the burner unit, movement of the burner unit movement body between a first position and a second position causes the burner unit to correspondingly move between the use position and the non-use position.

In one or more embodiments of the disclosures made herein, the gas appliance further comprises an actuation device enabler attached to the burner unit movement body, where the actuation device enabler causes the actuation device to be in the first state of operability when the burner unit movement body is in the first position and causes the actuation device to be in the second state of operability when the burner unit movement body is moved to a position away from the first position.

These and other objects, embodiments, advantages and/or distinctions of the present invention will become readily apparent upon further review of the following specification, associated drawings and appended claims.

### BRIEF DESCRIPTION OF THE DRAWINGS

Embodiments of disclosures made herein may take physical form in certain parts and arrangement of part, and embodiments thereof which are described in detail and illustrated in the accompanying drawings which form a part hereof, and wherein:

FIG. 1 is a perspective, partially-exploded view of a gas appliance configured in accordance with one or more embodiments of the disclosures made herein, where a burner unit thereof has a partially aerated gas burner and where the burner unit is shown is in a use position thereof;

FIG. 2 is a front perspective view of the gas appliance of FIG. 1 with maintenance panel removed and ash pan extended;

FIG. 3 is a perspective, partial cut-away view of the gas appliance of FIG. 1, where the burner unit is shown in the use position;

FIG. 4 is a perspective, partial cut-away view of the gas appliance of FIG. 1, where the burner unit is shown rotated to a non-use (i.e., dump) position;

FIG. 5 is a perspective view of a burner unit subassembly of the gas appliance of FIG. 1, where the burner unit is in the use position;

FIG. 6 is an exploded view of the burner unit subassembly of FIG. 5, where the burner unit is shown rotated to the non-use position;

FIG. 7 is an exploded view of the burner unit subassembly of FIG. 5, where control panel, gas control valves, and knobs are omitted;

FIG. 8 is a perspective detail view from FIG. 5, showing a control plate and a venturi plate of the gas appliance;

FIG. 9 is a perspective, partially-exploded view from FIG. 5, showing the control plate and the venturi plate of the gas appliance;

FIG. 10 is an overhead, partial view of the burner unit subassembly of FIG. 5, with a burner unit mounting shaft thereof shown as being longitudinally displaced from a spring-biased, at-rest position thereof;

FIG. 11 is an enlarged view of detail B of FIG. 10;

FIG. 12 is an enlarged view of detail A of FIG. 10;

FIG. 13 is an overhead, partial view of the burner unit subassembly of FIG. 5, with a burner unit mounting shaft thereof shown as being in the spring-biased, at-rest position thereof;

FIG. 14 is an enlarged view of detail D of FIG. 13;

FIG. 15 is an enlarged view of detail C of FIG. 13;

FIG. 16 is a rear, enlarged, partial perspective view of the control plate and cooperative elements thereof of the gas appliance of FIG. 1;

FIG. 17 is a perspective, partial cut-away view of a gas appliance configured in accordance with one or more embodiments of the disclosures made herein, where a burner unit thereof has a radiant gas burner and where the burner unit is shown is in a use position;

FIG. 18 is a perspective, partial cut-away view of the gas appliance of FIG. 17, where the burner unit is shown rotated to a non-use (e.g., down) position;

FIG. 19 is a front perspective view of the gas appliance of FIG. 17 with maintenance panel removed;

FIG. 20 is a perspective view of a burner unit subassembly of the gas appliance of FIG. 17, where the burner unit is in the use position;

FIG. 21 is an exploded view of the burner unit subassembly of FIG. 18, where the burner unit is shown rotated to the non-use position;

FIG. 22 is a top perspective view of a burner unit subassembly of FIG. 17, where the burner unit thereof is in the use position;

FIG. 23 is an enlarged view of detail E of FIG. 22;

FIG. 24 is a side view of the burner unit subassembly shown in FIG. 22;

FIG. 25 is an enlarged view of detail F of FIG. 24;

FIG. 26 is a side view of the burner unit subassembly shown in FIG. 22, where the burner unit thereof is in the down (i.e., non-use) position;

FIG. 27 is an enlarged view of detail G of FIG. 26;

FIG. 28 is a rear, enlarged, partial perspective view of the control plate and cooperative elements thereof of the gas appliance of FIG. 17;

FIG. 29 is an alternate embodiment of the control plate and cooperative elements thereof FIG. 17, showing an external solenoid; and

FIG. 30 is a side view of FIG. 29.

### DETAILED DESCRIPTION

Referring now to the drawings, wherein the depictions thereof are for the purpose of illustrating disclosed embodiments and not for the purpose of limiting the invention. In some instances, common components of different embodiments may be identified by the same reference numeral.

### First Embodiment

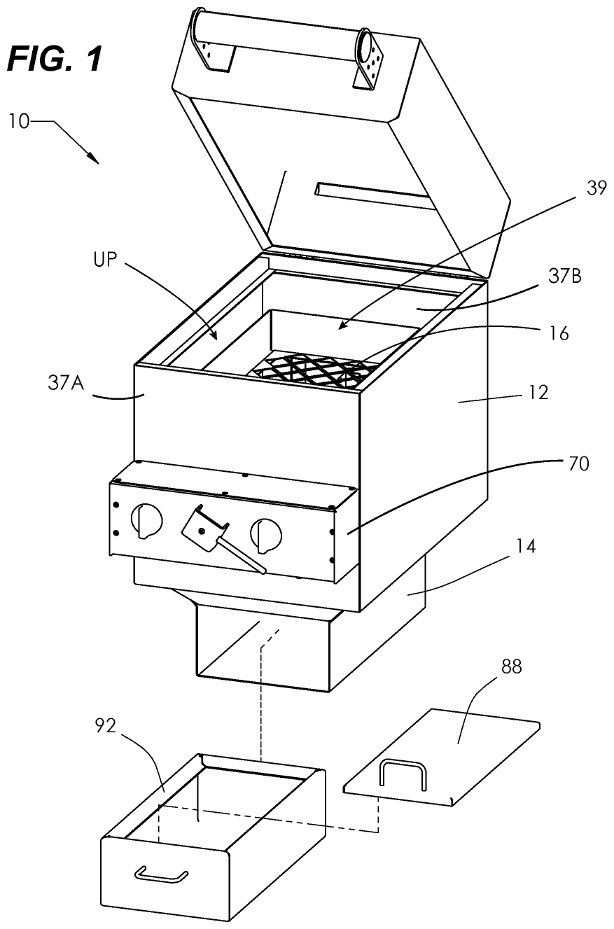

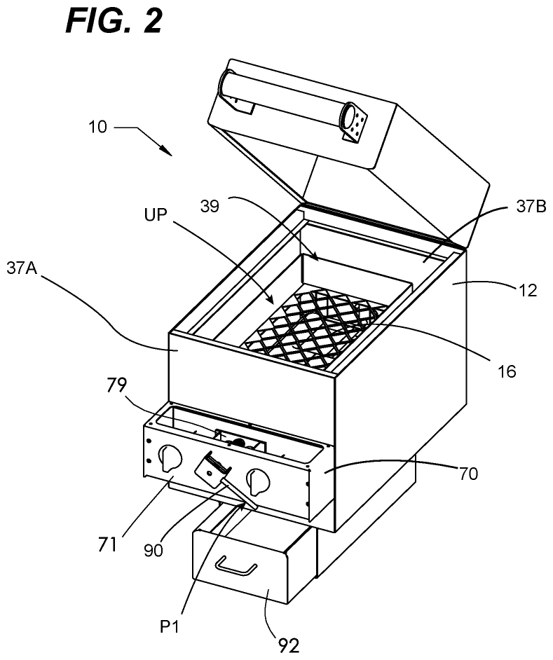

Referring to FIGS. 1-7, a gas appliance configured in accordance with a first embodiment (i.e., gas appliance 10) is disclosed. Where gas appliance 10 is a cooking grill, appliance housing 12 is a grill body. Gas burner body 38, crib 53 (i.e., a solid fuel support structure), gas burner 60 are fixedly attached to each other to jointly define a burner unit 39—i.e., of a burner unit subassembly comprising components that enable rotation of burner unit 39 relative to appliance housing 12. As shown, gas burner 60 is of the partially aerated type. Burner unit 39 is located within an interior space of appliance housing 12. Lid 62 may be movably attached to appliance housing 12 for enabling an opening in an upper face of appliance housing 12, through which the interior space of appliance housing 12 is accessed, to be selectively covered.

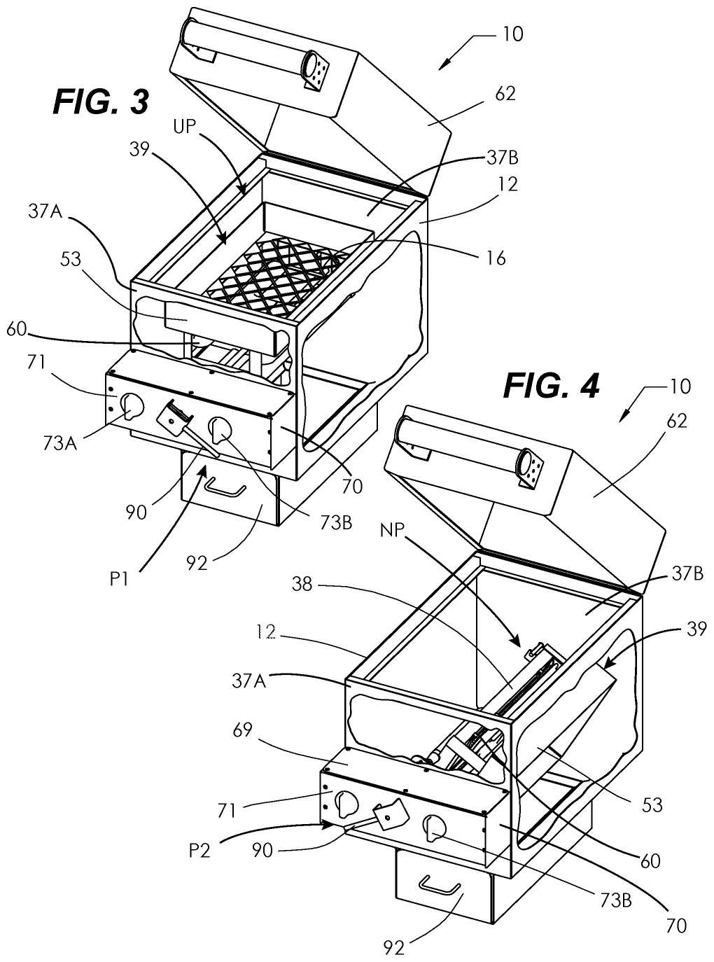

Burner unit 39 is selectively movable between use position UP and non-use position NP. Use position UP is preferably a position where a heat emitting major surface of the gas burner 60 is facing vertically upward and non-use position NO is a position where a heat emitting major surface of the gas burner 60 is rotated away from facing vertically upward. Advantageously, when rotated to or sufficiently toward non-use position NP from use position UP, crib 53 (FIG. 3) will dump solid fuel contents thereof (e.g., unburned fuel and/or ash from burned fuel) into ash pan 92. Thus, in some embodiments, non-use position NP is may be referred to as a dump position or solid fuel dump position. Grating 16 of crib 53 may be configured (e.g., opening dimension size) such that ashes from burned solid fuel may fall through grating 16. Any ashes present on top of gas burner 60 fall off of gas burner 60 when rotary shaft 45 (i.e., a burner unit mounting shaft) is moved sufficiently toward non-use (i.e., dump) position NP.

Subsequent to solid fuel being dumped into ash pan 92, a user may fully or partially disengage ash pan 92 from ash pan receiver 14 and cover the upper opening of ash pan 92 with ash pan lid 88. Solid fuel is now held within the enclosed confines of ash pan 92 and lid 88 and solid fuel combustion will become terminated due to lack of oxygen. Thus, remaining solid fuel life in ash pan 92 will be preserved and be available for a subsequent cooking instance. The rotation, dump, and solid fuel recovery functionality of gas appliance 10 is an increase in bandwidth over the conventional gas appliance art, where solid fuel combustion cannot be terminated by conveniently dumping and then containing the solid fuel in an integral ash pan without contamination or damage of the gas burner.

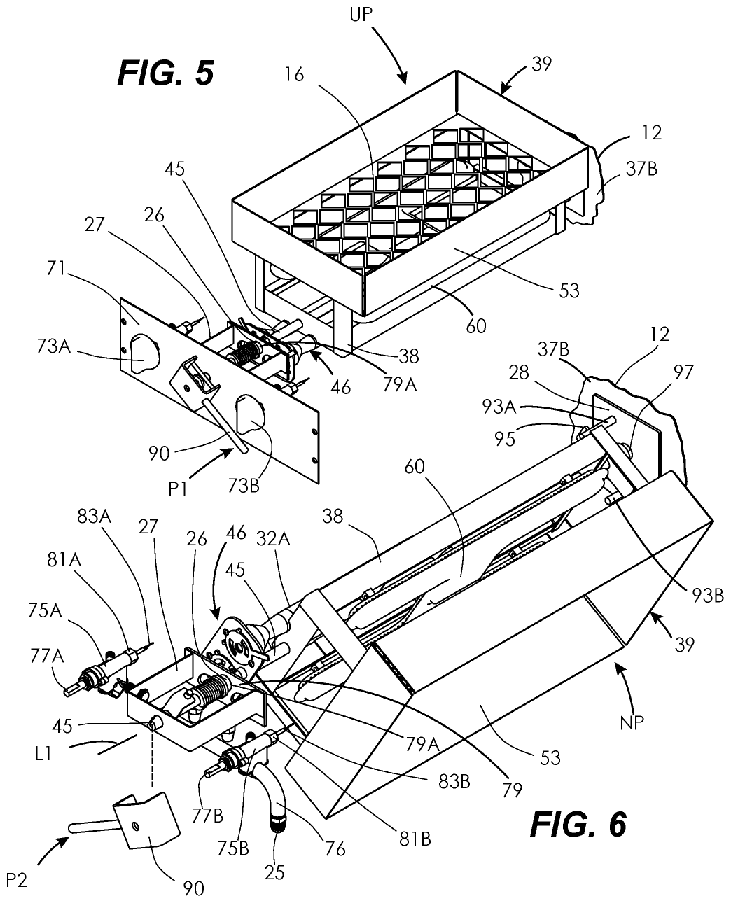

As best shown in FIGS. 4 and 6, burner unit 39 is fixedly attached to rotary shaft 45. Opposing end portions of rotary shaft 45 are attached to the appliance housing 12 for enabling burner unit 39 to be rotated between use position UP and non-use position NP. For example, rotary shaft 45 may have opposing end portions thereof rotatably mounted on bored plate 79 and back plate 28, which are each in turn fixedly attached to a respective wall of appliance housing 12 (e.g., front wall 37A and rear wall 37B, respectively). In one or more embodiments, bored plate 79 may be a portion of a wall of appliance housing 12 and back plate 28 may be a portion of a wall of appliance housing 12. In one or more embodiments, rotary shaft 45 may have a first end portion thereof rotatably mounted on bored plate 79 through a first bearing 26 and may have a second end portion thereof rotatably mounted on back plate 28 through a second bearing 97, as shown in FIGS. 5 and 6.

Shaft lever 90 and rotary shaft 45 jointly define a burner unit movement body that is fixedly attached to burner unit 39 and rotatably attached to appliance housing 12. Shaft lever 90 is attached to a proximate end portion of rotary shaft 45. To this end, the proximate end portion of rotary shaft 45 extends hole 79A in bored plate 79, hole 27A in mounting bracket 27 and a corresponding hole in control panel 71. Maintenance panel 69 and control panel 71 are attached to appliance housing 12 (e.g., to manifold portion 70), mounting bracket 27 is attached to control panel 71 and bored plate 79 is attached to mounting bracket 27. First bearing 26, through which the proximate end portion of rotary shaft 45 extends, is engaged within hole 79A of bored plate 79. Movement of shaft lever 90 results in corresponding rotation of rotary shaft 45 relative to appliance housing 12 and corresponding rotation of burner unit 39 relative to appliance housing 12. Thus, as best shown in FIGS. 3-6, movement of shaft lever 90 between a first rotary shaft position P1 and a second rotary shaft position P2 results in corresponding movement of burner unit 39 between use position UP and non-use position NP.

Referring to FIGS. 5-7, stop pins 93A, 93B of back plate 28 interact with flag 95 of rotary shaft 45 for defining use position UP and non-use position NP. Stop pin 93A is positioned to limit rotation of rotary shaft 45 to a position where burner unit 39 is in non-use position NP and stop pin 93B is positioned to limit rotation of rotary shaft 45 to a position where burner unit 39 is in use position UP. Cup 96, which is attached to rotary shaft 45 and/or the back of flag 95, covers second bearing 97 to protect second bearing 97 from falling debris, liquids crumbs and other contaminants.

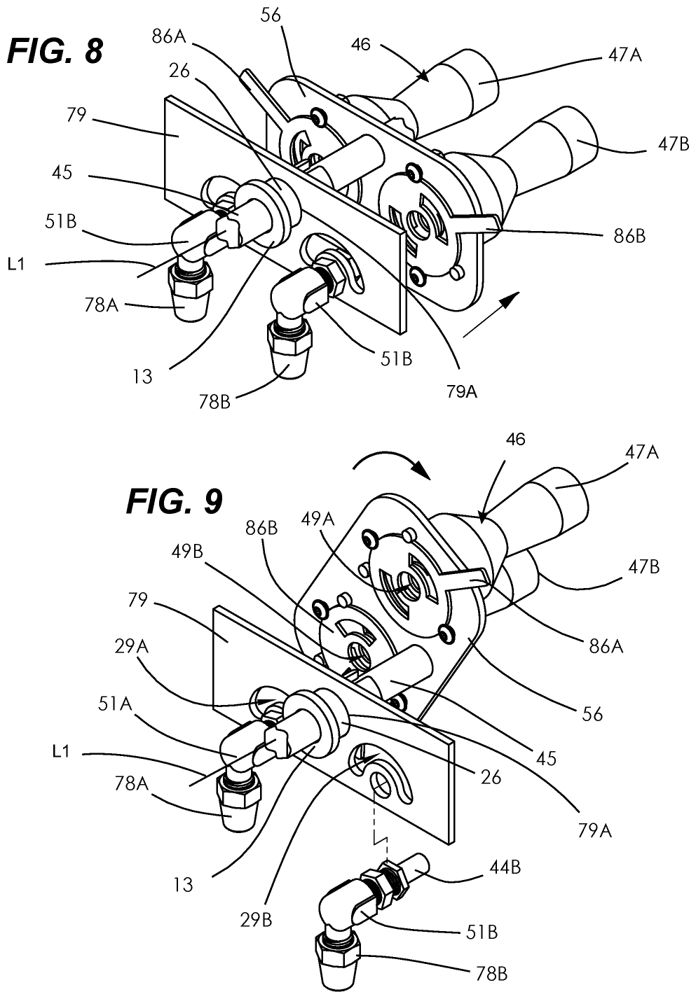

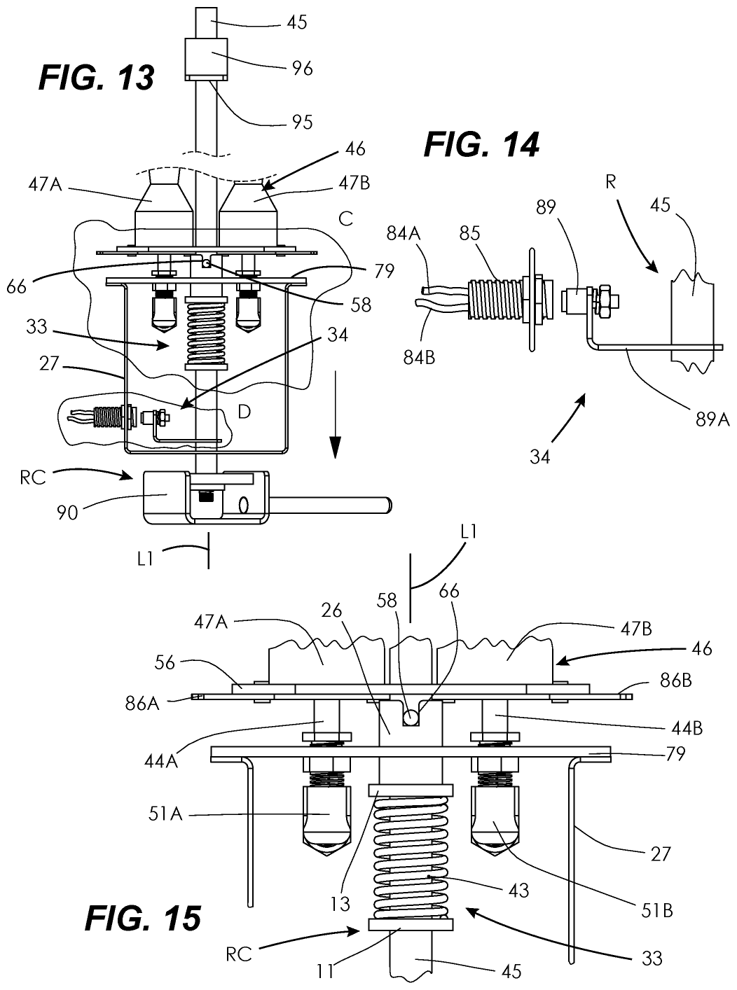

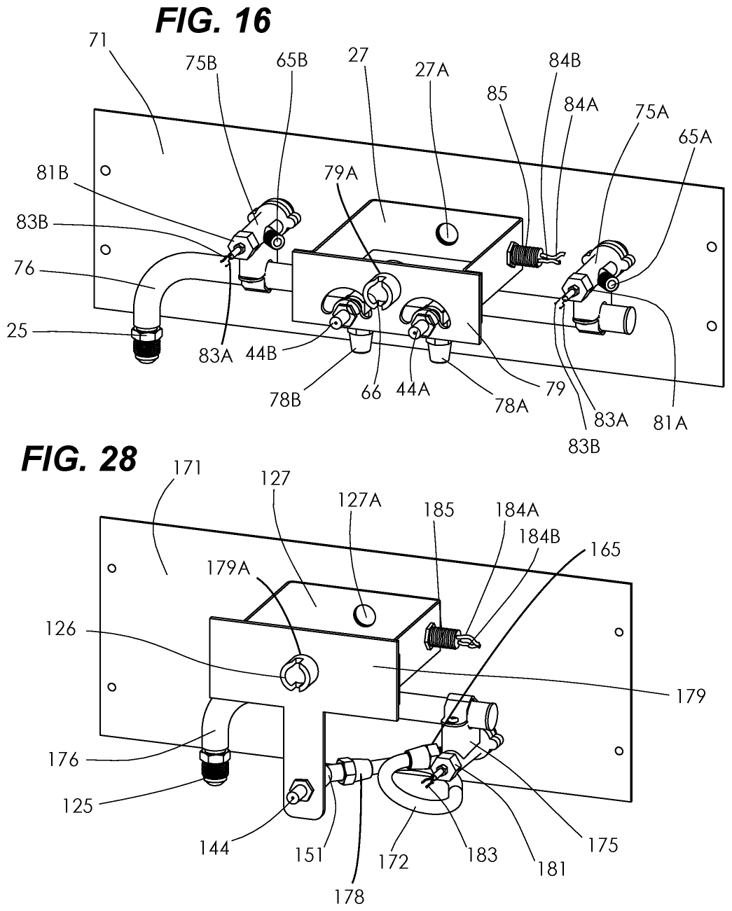

Referring now to FIGS. 5-16, a key aspect of the disclosures made herein is that rotational and, optionally, axial movement of the burner unit 39 relative to gas orifice assemblies 51A, 51B requires gas flow through orifice assemblies 51A, 51B to be enabled only when spuds 44A, 44B of gas orifice assemblies 51A, 51B are align with and, optionally, extend into central passages of venturis 47A, 47B of burner unit 39. Otherwise, the potential exists for gaseous fuel to be emitted from spuds 44A, 44B of gas orifice assemblies 51A, 51B when burner unit 39 is in non-use position NP. Gaseous fuel being emitted from spuds 44A, 44B of gas orifice assemblies 51A, 51B when burner unit 39 is in non-use position NP presents a safety issue arising from unburned gaseous fuel accumulating within the appliance housing 12.

Gas appliance 10 includes a gas flow control arrangement that addresses the abovementioned consideration of gaseous fuel being emitted from spuds 44A, 44B when burner unit 39 is in non-use position NP resulting in a safety issue arising from unburned gaseous fuel accumulating within the appliance housing 12. Gas flow control arrangement provides for gaseous fuel flow through orifice assemblies 51A, 51B being enabled only when spuds 44A, 44B of gas orifice assemblies 51A, 51B are align with and, optionally, extend into central passages of venturis 47A, 47B of burner unit 39. To this end, the gas flow control arrangement enables gaseous fuel to flow through orifice assemblies 51A, 51B when burner unit 39 is in use position UP and automatically inhibits such flow when burner unit 39 is moved away from use position UP.

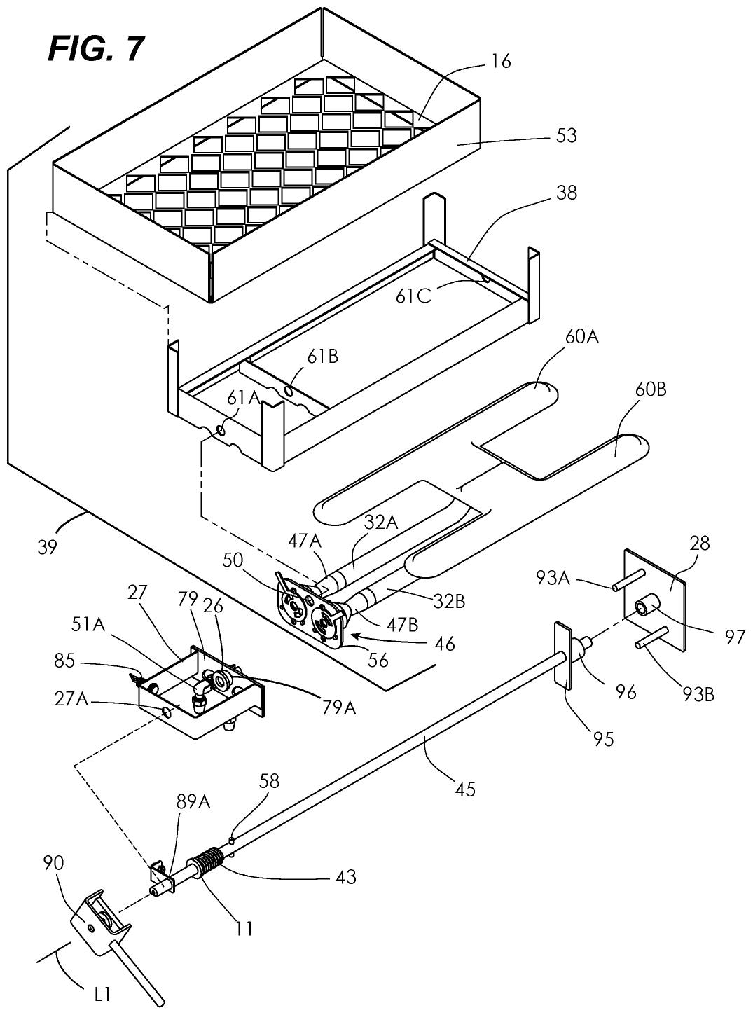

The gas flow control arrangement includes rotary shaft bias device 33, valve control apparatus 34, rotary shaft 45, venturi assembly 46, gas orifice assemblies 51A, 51B, gas control valves 75A, 75B and bored plate 79. As previously discussed, rotary shaft 45 is rotatably engaged with appliance housing 12. Venturis 47A, 47B are attached to gas burner 60 via burner feed pipes 32A, 32B. Gas orifice assemblies 51A, 51B are attached to bored plate 79. Gas control valves 75A, 75B are attached to control panel 71. Gas burner 60 has two sides, burner 60A, 60B, as shown in FIG. 7. Burner 60A, 60B receives a stoichiometric mix of gaseous fuel and primary air by fluid connection to burner feed pipes 32A, 32B in a way well known to the partially aerated burner art. Or in other words, burner feed pipes 32A, 32B are attached to burner 60A, 60B such that stoichiometric gas enters into gas burner 60 as needed for combustion. Venturi plate 56 has a shaft hole 50 that is welded or otherwise affixed to rotary shaft 45 in proximity to shaft pin 58. Gas burner body 38 is also welded or otherwise affixed to rotary shaft 45 at holes 61A, 61B, 61C of the gas burner body 38.

As best shown in FIGS. 5, 6 and 16, supply of gaseous fuel (natural gas, propane, LPG, etc.) is plumbed to gas inlet fitting 25 of supply pipe 76. The gaseous fuel is transmitted through pipe 76 to gas control valves 75A, 75B. Output ports 65A, 65B of gas control valves 75A, 75B are plumbed to gas orifice assemblies 51A, 51B at their respective inlet 78A, 78B via conduits (not shown, but may each be similar in structure and function to conduit 172 in FIG. 28). In this manner, gaseous fuel flowing through supply pipe 76 from gas inlet fitting 25 is supplied through gas control valves 75A, 75B to gas orifice assemblies 51A, 51B and thus to venturis 47A, 47B of gas burner 60. A user manipulates gas knobs 73A, 73B and thereby gas valve stems 77A, 77B to adjust flow levels of the gaseous fuel.

As best shown in FIGS. 5,6, 8 and 9, venturi plate 56 moves with rotary shaft 45, and hence parts attached to plate 56 also move. Venturi plate 56 serves as a substrate for venturis 47A, 47B. Venturis 47A, 47B may be welded into or otherwise formed as part of venturi plate 56. Air shutters 86A, 86B may be attached to venturi plate 56, and may be adjusted for air flow, and hence operate in a manner well known to the prior art for venturi air shutters. Within air shutter 86A, 86B are venturi inlet holes 49A, 49B. Inlet holes 49A, 49B have annotations arrows, where arrows indicate that spuds 44A, 44B insert or remove from inlet holes. Gas orifice assemblies 51A, 51B are in fluid communication with gas control valves 75A, 75B. Primary air holes 29A, 29B are formed in bored plate 79. Primary air needed for operation of gas burner 60 flows through primary air holes 29A, 29B. Primary air holes 29A, 29B are in alignment with venturis 47A, 47B when burner unit 39 is in use position UP.

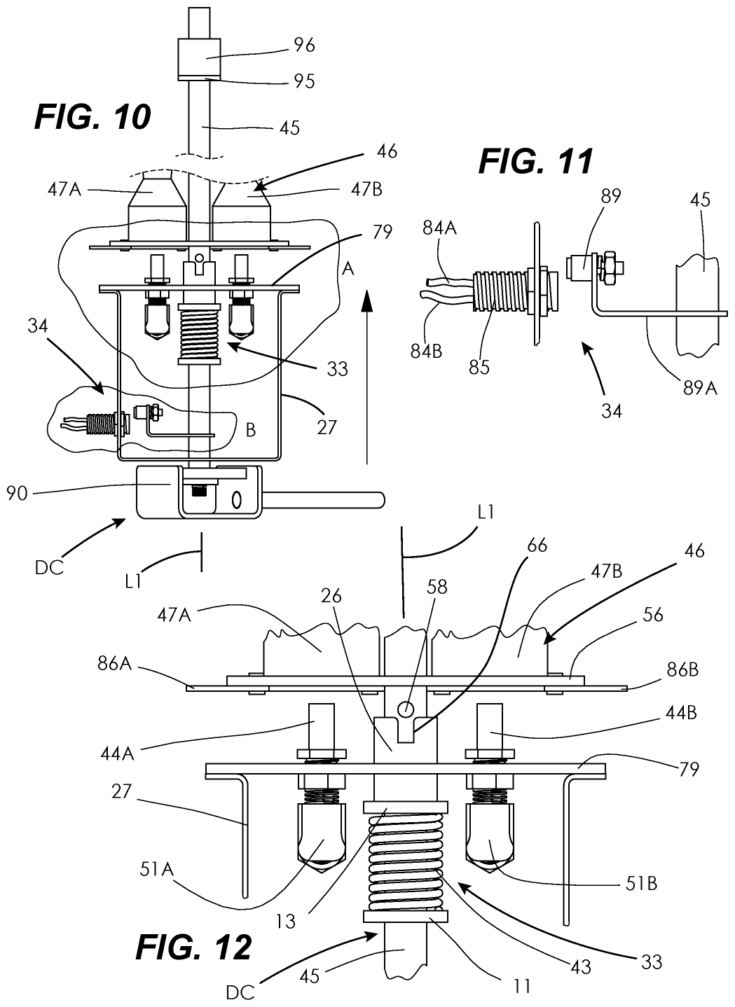

As best shown in FIGS. 13 and 15, spuds 44A, 44B (i.e., fuel delivery portions) of gas orifice assemblies 51A, 51B align with and, optionally, extend into central passages of venturis 47A, 47B of burner unit 39. As discussed above, burner unit 39 rotates relative to appliance housing 12, bored plate 79 is fixedly attached to appliance housing 12 and gas orifice assemblies 51A, 51B are fixedly attached to bored plate 79. Thus, rotation of the burner unit 39 from use position UP toward non-use position NP requires rotational and axial movement of the burner unit 39 (and therefor venturi assembly 46 thereof) relative to gas orifice assemblies 51A, 51B. To this end, as best shown in FIGS. 7, 8 and 10-15, rotary shaft 45 can both rotate and axially translate relative to the appliance housing 12. Specifically, rotary shaft 45 is rotatable about and axially translatable along centerline longitudinal axis L1.

Referring to FIGS. 10, 12, 13 and 15, rotary shaft bias device 33 comprises first bearing 26, compression spring 43, shaft pin 58, first washer 11 and second washer 13. Shaft pin 58 extends into and protrudes from rotary shaft 45. First bearing 26 includes pin receptacle 66 within an end portion thereof facing shaft pin 58. Washer 11 is attached to rotary shaft 45 at a given axial position along the length of rotary shaft 45—e.g., by welding, mechanical fastener or other suitable means. Second washer 13 abuts an end face of first bearing 26 that faces first washer 11. Second washer 13 may be a unitary element of first bearing 26. Compression spring 43 is disposed on rotary shaft 45 between first and second washers 11, 13 in a compressed state.

Compression spring 43 biases rotary shaft 45 to a resting configuration R where shaft pin 58 is seated within pin receptacle 66. Pin receptacle 66 is sized to enable spuds 44A, 44B to be engaged with (e.g., disposed within or mounted on) venturis 47A, 47B when rotary shaft 45 is in resting configuration R. Such engagement of spuds 44A, 44B with venturis 47A, 47B (e.g., end portions of spuds 44A, 44B being disposed within venturi holes 49A, 49B) is required for nominal gas-air mass transfer function of venturi operation. Preferably, spuds 44A, 44B are dimensioned to fit inside of venturi inlet holes 49A, 49B. First bearing 26 is inhibited from movement relative to bored plate 79. In one or more embodiments, first bearing 26 may be welded to or otherwise fixedly attached to bored plate 79 and may be engaged within (e.g., extend into) hole 79A of bored plate 79. Accordingly, while rotary shaft 45 in in resting configuration R, rotational movement of rotary shaft 45 and, thus, gas burner 60 and spuds 44A, 44B of gas orifice assemblies 51A, 51B are aligned with and extend into central passages of venturis 47A, 47B of burner unit 39. Exertion of axial force on rotary shaft 45 overcomes the aforementioned spring biasing for causing rotary shaft 45 to transition from resting configuration RC (FIGS. 13 and 15) to displaced configuration DC (FIGS. 10 and 12). As shown in FIGS. 10 and 12, rotary shaft 45 may be translated axially such that the shaft pin 58 is no longer seated within pin receptacle 66 and spuds 44A, 44B of gas orifice assemblies 51A, 51B no longer extend into central passages of venturis 47A, 47B. In this manner, rotary shaft 45 can then be rotated for causing burner unit 39 to move from use position UP fully or partially toward non-use position NP such that spuds 44A, 44B of gas orifice assemblies 51A, 51B are no longer operably aligned with the central passages of venturis 47A, 47B of burner unit 39 and such that unburned solid fuel is dumped from crib 53 of the burner unit 39.

As discussed above, the flow control arrangement provides for gaseous fuel flow through orifice assemblies 51A, 51B only when spuds 44A, 44B of gas orifice assemblies 51A, 51B are operably aligned with and, optionally, extend into central passages of venturis 47A, 47B—i.e., rotary shaft 45 is in resting configuration R. To this end, valve control apparatus 34 and solenoids 81A, 81B (i.e., gas flow actuation devices) of gas control valves 75A, 75B jointly provide for such selective gaseous fuel flow through orifice assemblies 51A, 51B. As best shown in FIGS. 11, 14 and 16, solenoids 81A, 81B have wires 83A, 83B that is operably connected to wires 84A, 84B of magnetic switch 85. Control valves 75A, 75B are in a normally-closed state such that gas flow therethrough is inhibited while solenoids 81A, 81B thereof are de-energized. When energizing current for solenoids 81A, 81B is provided via wires 83A, 83B and a power supply (not specifically shown), solenoids 81A, 81B cause control valves 75A, 75B to transition to a state of operation in which gas flow through control valves 75A, 75B and, thus, orifice assemblies 51A, 51B is permitted.

As best shown in FIGS. 10, 11, 13, 14 and 16, magnet 89 (i.e., an actuation device trigger) is attached to the rotary shaft 45 such as, for example, via magnet mount 89A. Based on relative positioning of magnet 89 and magnetic switch 85 (i.e., actuation device), magnet 89 causes magnetic switch 85 to be in the first state of operability when the rotary shaft 45 is in the first rotary shaft position P1 and causes magnetic switch 85 to be in the second state of operability when the rotary shaft 45 is rotated to move burner unit 39 to a position away from use position UP. To this end, moving shaft lever 90 (along with rotary shaft 45) from the first rotary shaft position P1 toward the second rotary shaft position P2 (i.e., including the rotary shaft 45 being axially translated to the displaced configuration DC) causes magnetic switch 85 to transition from receiving actuation signal from magnet 89 to not receiving actuation signal from magnet 89—i.e., magnet being moved to a position where magnetic switch 85 does not receive actuation signal. When magnetic switch 85 to transitions from receiving actuation signal from magnet 89, contacts open within magnetic switch 85 as is known in the art for switches of this type. Upon contact closure, electrical current may pass through magnetic switch 85 (e.g., via wires 84A, 84B thereof), solenoids 81A, 81B (e.g., via wires 83A, 83B thereof) and a power supply (not shown) for causing normally-closed gas control valves 75A, 75B to be opened for enabling gaseous fuel to flow therethrough.

### Second Embodiment

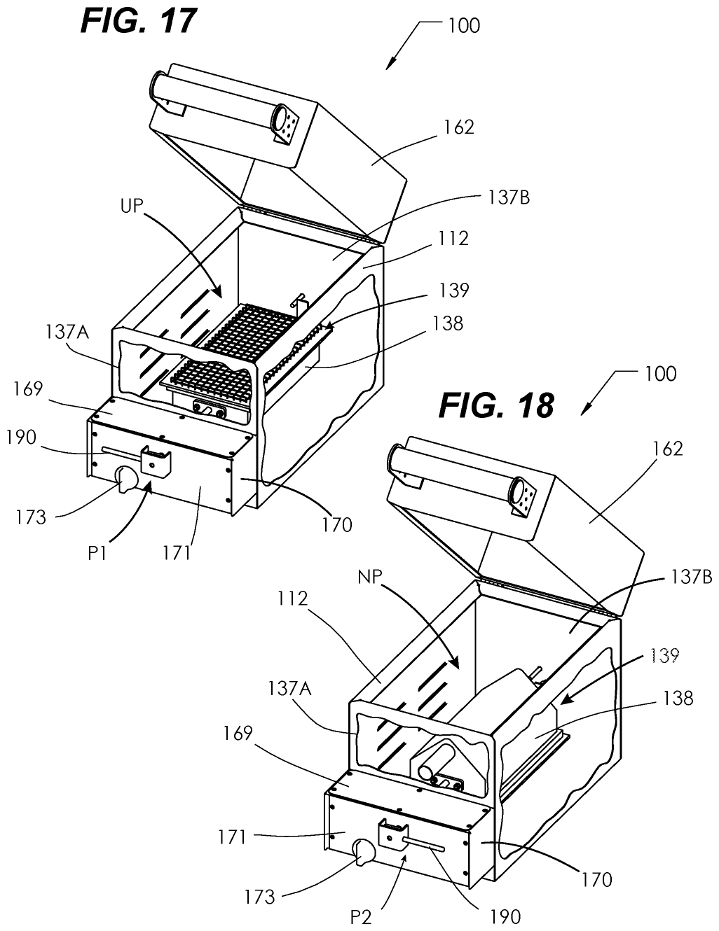

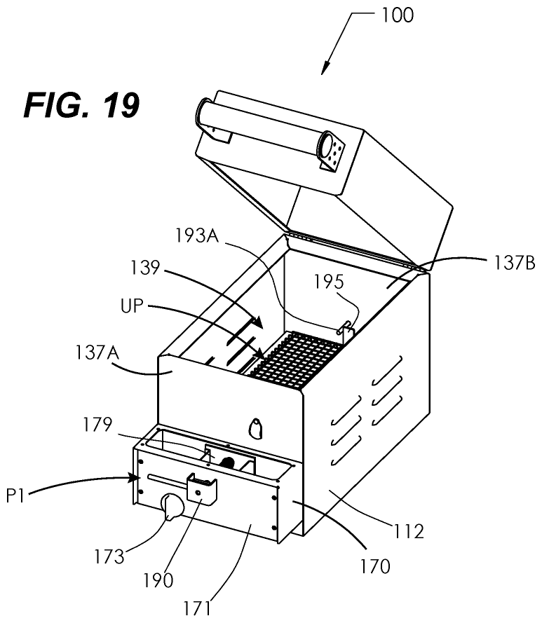

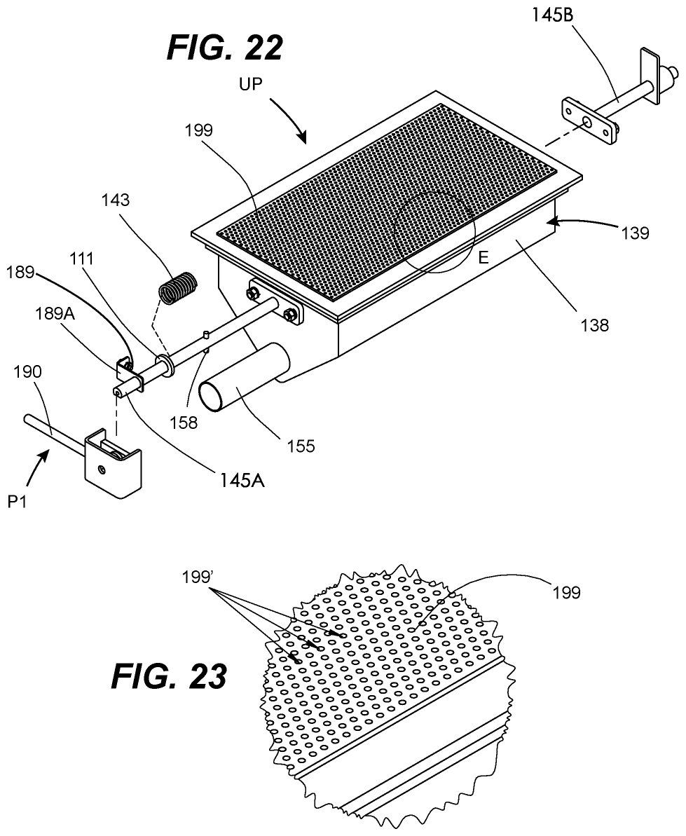

Referring now to FIGS. 17-23, a gas appliance configured in accordance with a second embodiment (i.e., gas appliance 100) is disclosed. The underlying difference between gas appliance 100 and gas appliance 10 is that burner unit 139 of gas appliance 100, which is located within an interior space of appliance housing 112, is of a radiant type whereas gas burner 60 of burner unit 39 of gas appliance 10 is of the partially aerated type. Disclosed elements of gas appliance 100 that share a respective related reference numeral to a disclosed element of gas appliance 10 provides the same or functionally equivalent operability thereto. Such same or functionally equivalent elements will not necessarily be discussed in reference to gas appliance 100.

Burner unit 139 includes gas burner body 138, plain air mixer 155, mesh screen 164 and radiant panel 199. Radiant panel 199 may be made of (e.g., molded) ceramic with many small ports 199′. Gas burner body 138 and radiant panel 199 jointly define an interior space within which combustion of gaseous fuel occurs. Plain air mixer 155 serves as an inlet structure for gaseous fuel and plain ambient air into such interior space.

In use, carbon and certain other combustible materials that may become deposited onto mesh screen 164 and radiant panel 199. Radiant heat emitted from the burner unit 139 reduces such carbon and certain other combustible materials to ash. But, when burner unit 139 is not in use, it is vulnerable to contamination and damage as carbon reduction self-cleaning function is lost. For example, when burner unit 139 is off and in use position UP, falling fats, crumbs and debris may foul ports 199′ of radiant panel 199.

Advantageously, burner unit 139 is selectively movable between use position UP and non-use (e.g., downward facing) position NP. When rotated to or sufficiently toward non-use position NP from use position UP, radiant panel 199 is protected from being fouled as a result of radiant panel 199 being in the shadow of and, thus, shielded by the backside of gas burner body 138. Advantageously, gas appliance 100 has the useful and convenient function of rotating burner unit 139 to non-use position NP (i.e., downward facing position) for cleaning and storing. Storing burner unit 139 in non-use position NP enables gas appliance 100 to be weather resistant as rain or moisture collected in the interior space of burner unit 139 will generally drain out though ports 199′ of radiant panel 199.

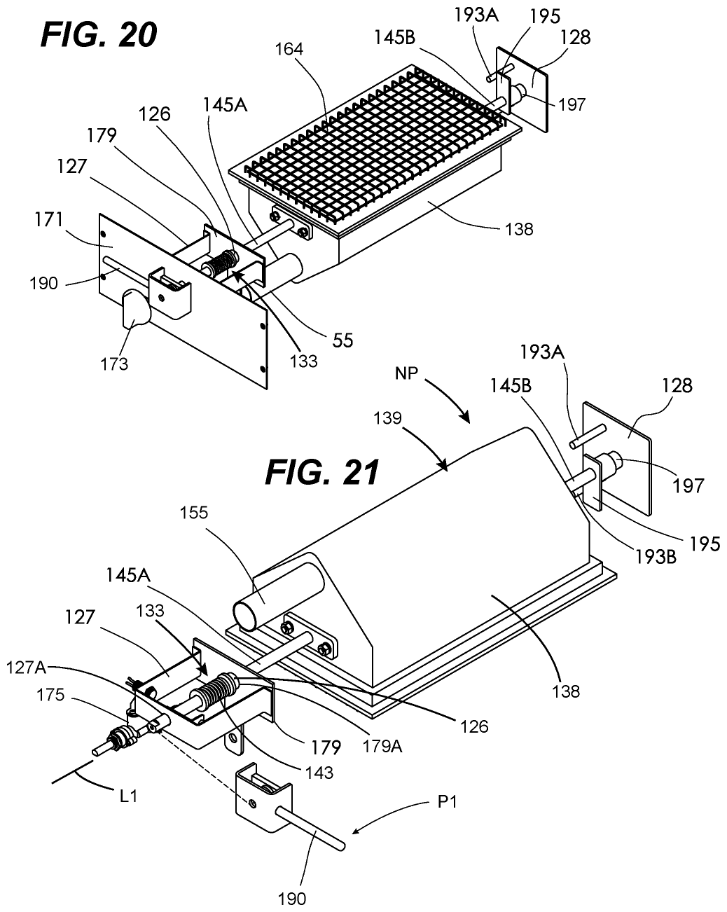

As best shown in FIGS. 20-22, burner unit 139 is fixedly attached to rotary shaft 145. As shown, rotary shaft 145 may be jointly formed by shafts 145A and 145B. Opposing end portions of rotary shaft 145 may be directly or indirectly attached to the appliance housing 112 for enabling burner unit 139 to be rotated between use position UP and non-use position NP. For example, rotary shaft 145 may be rotatably mounted on bored plate 179 and back plate 128, which are each in turn fixedly attached to a respective wall of appliance housing 112 (e.g., front wall 137A and rear wall 137B, as shown in FIGS. 17-19). In one or more embodiments, bored plate 179 may be a portion of a wall of appliance housing 112 and back plate 128 may be a portion of a wall of appliance housing 112. In one or more embodiments, rotary shaft 145 may be rotatably mounted on bored plate 179 through first bearing 126 and on back plate 128 through second bearing 197, as shown in FIGS. 20 and 21.

Shaft lever 190 and rotary shaft 145 jointly define a burner unit movement body that is attached to burner unit 139. Shaft lever 190 is attached to a proximate end portion of rotary shaft 145. To this end, the proximate end portion of rotary shaft 145 extends through hole 179A in bored plate 179, hole 127A in mounting bracket 127 and a corresponding hole in control panel 171. Control panel 171 is attached to appliance housing 112 (e.g., to manifold portion 170), mounting bracket 127 is attached to control panel 171 and bored plate 179 is attached to mounting bracket 127. First bearing 126, through which the proximate end portion of rotary shaft 145 extends, is engaged within hole 179A of bored plate 179. In one or more embodiments, first bearing 126 may be welded to or otherwise fixedly attached to bored plate 179 and may be engaged within (e.g., extend into) hole 179A of bored plate 179. Movement of shaft lever 190 results in corresponding rotation of rotary shaft 145 relative to appliance housing 112 and, thus, corresponding rotation of burner unit 139 relative to appliance housing 112. Thus, as best shown in FIGS. 17-21, movement of shaft lever 190 between first rotary shaft position P1 and second rotary shaft position P2 results in corresponding movement of burner unit 139 between use position UP and non-use position NP.

Referring now to FIGS. 20-21 and 24-27, rotational and axial movement of the burner unit 139 relative to gas orifice assembly 151 requires gas flow through orifice assemblies 151 to be enabled only when spud 144 of gas orifice assembly 151 is align with and, optionally, extend into central passage of plain air mixer 155 of burner unit 139. Otherwise, the potential exists for gaseous fuel to be emitted from spud 144 of gas orifice assembly 151 when burner unit 139 is in non-use position NP, which presents a safety issue arising from unburned gaseous fuel accumulating within the appliance housing 112.

Gas appliance 100 includes a gas flow control arrangement that addresses the abovementioned consideration of gaseous fuel being emitted from spud 144 when burner unit 139 is in non-use position NP resulting in a safety issue arising from unburned gaseous fuel accumulating within the appliance housing 112. Gas flow control arrangement provides for gaseous fuel flow through orifice assembly 151 being enabled only when spud 144 of gas orifice assembly 151 are align with and, optionally, extend into a central passage of plain air mixer 155. To this end, the gas flow control arrangement enables gaseous fuel to flow through orifice assembly 151 when burner unit 139 is in use position UP and automatically inhibits such flow when burner unit 139 is moved away from use position UP.

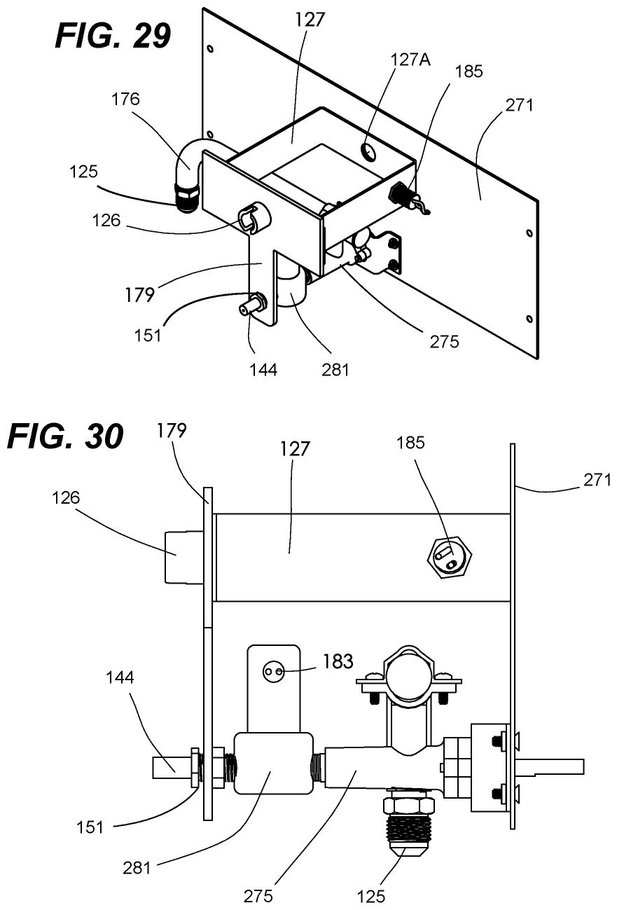

The gas flow control arrangement includes rotary shaft bias device 133, rotary shaft 145, plain air mixer 155, gas orifice assembly 151, bored plate 179, gas control valve 175 and a valve control apparatus (e.g., comprising solenoid 181, magnetic switch 185, magnet 189, magnet mount 189A, etc.). The valve control apparatus of the gas appliance 100 can be configured and operate in the same, similar or different manner as valve control apparatus 34 of gas appliance 10. Such operation enables gaseous fuel flow only when spud 144 of gas orifice assembly 151 is aligned with and, optionally, extends into central passage of plain air mixer 155 of burner unit 139—i.e., burner unit 139 is in use position UP (i.e., lever 190 is in first rotary shaft position P1). To this end, the valve control apparatus of gas appliance 100 may include the same, similar or different elements as the valve control apparatus 34 of gas appliance 10. For example, as shown in FIGS. 29 and 30, gas control valve 275 is coupled to external solenoid 281 as opposed to having an internal (i.e., integral) solenoid.

As best shown in FIG. 28, gas orifice assembly 151 may be fixedly attached to (i.e., integral with) bored plate 179. Gas control valve 175 may be fixedly attached to (i.e., integral with) control panel 171. Similarly, as shown in FIGS. 29 and 30, gas control valve 275 (i.e., omitting an internal solenoid) may be fixedly attached to (i.e., integral with) control panel 271. Supply of gaseous fuel (natural gas, propane, LPG, etc.) is plumbed to gas inlet fitting 125 of supply pipe 176. The gaseous fuel is transmitted through pipe 176 to gas control valves 175. Output port 165 of gas control valve 175 is plumbed to gas orifice assembly 151 the inlet 178 thereof via conduit 172. In this manner, gaseous fuel flowing through supply pipe 176 from gas inlet fitting 125 is supplied through gas control valve 175 to gas orifice assemblies 151 and thus into plain air mixer 155 of burner unit 139. A user manipulates gas knob 173 and thereby gas control valve 175 to adjust flow levels of the gaseous fuel.

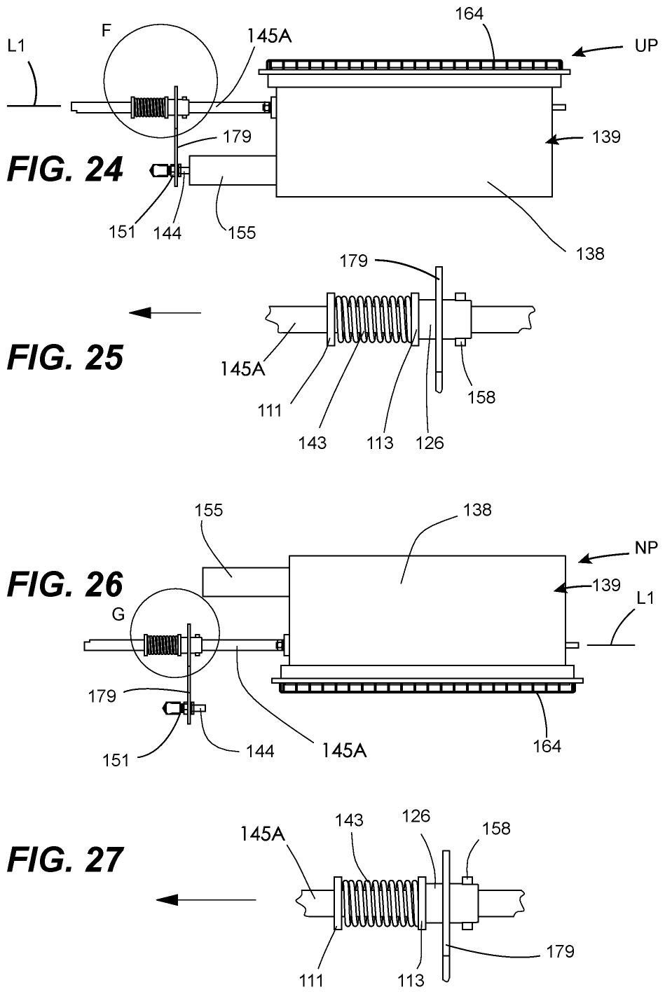

As best shown in FIG. 24, spud 144 (i.e., fuel delivery nozzle) of gas orifice assembly 151 aligns with and, optionally, extends into the central passage of plain air mixer 155 of burner unit 139. As discussed above, burner unit 139 rotates relative to appliance housing 112, bored plate 179 is fixedly attached to appliance housing 112 and gas orifice assembly 151 is fixedly attached to bored plate 179. Thus, rotation of the burner unit 139 from use position UP toward non-use position NP requires rotational and axial movement of the burner unit 139 (and therefor plain air mixer 155 thereof) relative to the gas orifice assembly 151. To this end, as best shown in FIGS. 20, 21, and 24-27, rotary shaft 145 can both rotate and axially translate relative to the appliance housing 112. Specifically, rotary shaft 145 is rotatable about and axially translatable along centerline longitudinal axis L1. Such ability and functionality for being rotatable about and axially translatable along centerline longitudinal axis L1 of the rotary shaft 145 is provided for by first and second washers 111, 113, compression spring 143, and shaft pin 158. This functionality ability and functionality is discussed in detail above in reference to rotary shaft bias device 33 of gas appliance 10.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the invention in all its aspects. Although the invention has been described with reference to particular means, materials and embodiments, the invention is not intended to be limited to the particulars disclosed; rather, the invention extends to all functionally equivalent technologies, structures, methods and uses such as are within the scope of the appended claims.

What is claimed is:

1. A gas appliance, comprising:
an appliance housing; and
a burner unit located at least partially within an interior space of the appliance housing, wherein the burner unit includes a gas burner and a gas burner body, wherein the burner unit is movably attached to the appliance housing for enabling the burner unit to be selectively moved between a use position thereof and a non-use position thereof and wherein the gas burner is integral with the gas burner body whereby the gas burner remains in a fixed orientation relative to the gas burner body when the burner unit is moved between the use position and the non-use position.

2. The gas appliance of claim 1 wherein the gas burner is one of a radiant burner and a partially aerated gas burner.

3. The gas appliance of claim 1 wherein:
when the burner unit is in the use position, a top face of the burner unit faces an opening within a top face of the appliance housing through which the interior space is accessible; and
when the burner unit is in the non-use position, the top face of the burner unit faces away from the opening within the top face of the appliance housing.

4. The gas appliance of claim 1 wherein:
the burner unit is rotatably attached to the appliance housing for being rotated about a rotation axis of the burner unit; and
the gas burner is located above the rotation axis when the burner unit is in the use position.

5. The gas appliance of claim 4 wherein:
when the burner unit is in the use position, a top face of the burner unit faces an opening within a top face of the appliance housing through which the interior space is accessible; and
when the burner unit is in the non-use position, the top face of the burner unit faces away from the opening within the top face of the appliance housing.

6. The gas appliance of claim 1 wherein:
the gas burner is a partially aerated gas burner;
the burner unit further includes a solid fuel support structure; and
the solid fuel support structure is integral with the burner unit to enable the solid fuel support structure to remain in a fixed orientation relative to the gas burner when the burner unit is moved between the use position and the non-use position.

7. The gas appliance of claim 6 wherein the solid fuel support structure is a fuel crib.

8. The gas appliance of claim 7 wherein:
the burner unit is rotatably attached to the appliance housing for being rotated about a rotation axis of the burner unit;
the gas burner is located above the rotation axis when the burner unit is in the use position; and
the solid fuel support structure is located above the gas burner when the burner unit is in the use position.

9. The gas appliance of claim 8 wherein:
when the burner unit is in the use position, a top face of the burner unit faces an opening within a top face of the appliance housing through which the interior space is accessible; and
when the burner unit is in the non-use position, the top face of the burner unit faces away from the opening within the top face of the appliance housing.

10. The gas appliance of claim 1 wherein:
the gas appliance further comprises a gas flow-control valve operably coupled to the gas burner and an actuation device operably coupled to the gas flow-control valve;
the gas flow-control valve enables gas flow to the gas burner to be at least one of selectively enabled and selectively disabled;
the actuation device causes the gas flow-control valve to at least one of enable gas flow to the gas burner when in a first state of operability and disable gas flow to the gas burner when in a second state of operability; and
the first state of operability corresponds to the burner unit being in the use position and the second state of operability corresponds to the burner unit being moved to a position away from the use position.

11. The gas appliance of claim 10, further comprising:
a burner unit movement body attached to the burner unit, wherein movement of the burner unit movement body between a first position and a second position causes the burner unit to correspondingly move between the use position and the non-use position; and
an actuation device enabler attached to the burner unit movement body, wherein the actuation device enabler causes the actuation device to be in the first state of operability when the burner unit movement body is in the first position and causes the actuation device to be in the second state of operability when the burner unit movement body is moved to a position away from the first position.

12. The gas appliance of claim 10 wherein:
when the burner unit is in the use position, a top face of the burner unit faces an opening within a top face of the appliance housing through which the interior space is accessible; and
when the burner unit is in the non-use position, the top face of the burner unit faces away from the opening within the top face of the appliance housing.

13. The gas appliance of claim 12, further comprising:
a burner unit movement body attached to the burner unit, wherein movement of the burner unit movement body between a first position and a second position causes the burner unit to correspondingly move between the use position and the non-use position; and
an actuation device enabler attached to the burner unit movement body, wherein the actuation device enabler causes the actuation device to be in the first state of operability when the burner unit movement body is in the first position and causes the actuation device to be in the second state of operability when the burner unit movement body is moved to a position away from the first position.

14. The gas appliance of claim 13 wherein
the burner unit is rotatably attached to the appliance housing for being rotated about a rotation axis of the burner unit; and
the gas burner is located above the rotation axis when the burner unit is in the use position.

15. A gas appliance, comprising:
an appliance housing; and
a burner unit located at least partially within an interior space of the appliance housing, wherein the burner unit includes a gas burner and a solid fuel support structure, wherein the burner unit is movably attached to the appliance housing for enabling the burner unit to be selectively moved between a use position thereof and a dump position thereof and wherein the gas burner and the solid fuel support structure are integral with the burner unit whereby the solid fuel support structure remains in a fixed orientation relative to the gas burner when the burner unit is moved between the use position and the dump position.

16. The gas appliance of claim 15 wherein:
when the burner unit is in the use position, a top face of the burner unit faces an opening within a top face of the appliance housing through which the interior space is accessible; and
when the burner unit is in dump position, the top face of the burner unit faces away from the opening within the top face of the appliance housing.

17. The gas appliance of claim 15 wherein:
the burner unit is rotatably attached to the appliance housing for being rotated about a rotation axis of the burner unit;
the gas burner is located above the rotation axis when the burner unit is in the use position; and
the solid fuel support structure is located above the gas burner when the burner unit is in the use position.

18. The gas appliance of claim 15 wherein:
the gas appliance further comprises a gas flow-control valve operably coupled to the gas burner and an actuation device operably coupled to the gas flow-control valve;
the gas flow-control valve enables gas flow to the gas burner to be at least one of selectively enabled and selectively disabled;
the actuation device causes the gas flow-control valve to at least one of enable gas flow to the gas burner when in a first state of operability and disable gas flow to the gas burner when in a second state of operability; and
the first state of operability corresponds to the burner unit being in the use position and the second state of operability corresponds to the burner unit being moved to a position away from the use position.

19. The gas appliance of claim 18, further comprising:
a burner unit movement body attached to the burner unit, wherein movement of the burner unit movement body between a first position and a second position causes the burner unit to correspondingly move between the use position and the dump position; and
an actuation device enabler attached to the burner unit movement body, wherein the actuation device enabler causes the actuation device to be in the first state of operability when the burner unit movement body is in the first position and causes the actuation device to be in the second state of operability when the burner unit movement body is moved to a position away from the first position.

20. The gas appliance of claim 18 wherein:
when the burner unit is in the use position, a top face of the burner unit faces an opening within a top face of the appliance housing through which the interior space is accessible; and
when the burner unit is in the dump position, the top face of the burner unit faces away from the opening within the top face of the appliance housing.

21. The gas appliance of claim 20, further comprising:
a burner unit movement body attached to the burner unit, wherein movement of the burner unit movement body between a first position and a second position causes the burner unit to correspondingly move between the use position and the dump position; and
an actuation device enabler attached to the burner unit movement body, wherein the actuation device enabler causes the actuation device to be in the first state of operability when the burner unit movement body is in the first position and causes the actuation device to be in the second state of operability when the burner unit movement body is moved to a position away from the first position.

22. The gas appliance of claim 21 wherein
the burner unit is rotatably attached to the appliance housing for being rotated about a rotation axis of the burner unit;
the gas burner is located above the rotation axis when the burner unit is in the use position; and
the solid fuel support structure is located above the gas burner when the burner unit is in the use position.

23. The gas appliance of claim 21 wherein
when the burner unit is in the use position, a top face of the burner unit faces an opening within a top face of the appliance housing through which the interior space is accessible; and
when the burner unit is in the dump position, the top face of the burner unit faces away from the opening within the top face of the appliance housing.

24. A cooking grill, comprising:
a grill body having one or more walls defining an interior space of the grill body; and
a burner unit located within the interior space of the grill body, wherein the burner unit is rotatably attached to the grill body for enabling the burner unit to be selectively rotated about a rotation axis of the burner unit between a use position thereof and a dump position thereof, wherein the burner unit includes a partially aerated gas burner and a solid fuel support structure, wherein the partially aerated gas burner and the solid fuel support structure are integral with the burner unit whereby the solid fuel support structure remains in a fixed orientation relative to the partially aerated gas burner when the burner unit is moved between the use position and the dump position, wherein the gas burner is located above the rotation axis when the burner unit is in the use position and the solid fuel support structure is located above the gas burner when the burner unit is in the use position.

25. The cooking grill of claim 24 wherein:
when the burner unit is in the use position, a top face of the burner unit faces an opening within a top face of the appliance housing through which the interior space is accessible; and
when the burner unit is in the dump position, the top face of the burner unit faces away from the opening within the top face of the appliance housing.

26. The cooking grill of claim 24 wherein:
the gas appliance further comprises a gas flow-control valve operably coupled to the gas burner and an actuation device operably coupled to the gas flow-control valve;
the gas flow-control valve enables gas flow to the gas burner to be at least one of selectively enabled and selectively disabled;
the actuation device causes the gas flow-control valve to at least one of enable gas flow to the gas burner when in a first state of operability and disable gas flow to the gas burner when in a second state of operability; and
the first state of operability corresponds to the burner unit being in the use position and the second state of operability corresponds to the burner unit being moved to a position away from the use position.

27. The cooking grill of claim 26, further comprising:
a burner unit movement body attached to the burner unit, wherein movement of the burner unit movement body between a first position and a second position causes the burner unit to correspondingly move between the use position and the dump position; and
an actuation device enabler attached to the burner unit movement body, wherein the actuation device enabler causes the actuation device to be in the first state of operability when the burner unit movement body is in the first position and causes the actuation device to be in the second state of operability when the burner unit movement body is moved to a position away from the first position.

28. The cooking grill of claim 26 wherein:
when the burner unit is in the use position, a top face of the burner unit faces an opening within a top face of the appliance housing through which the interior space is accessible; and
when the burner unit is in the dump position, the top face of the burner unit faces away from the opening within the top face of the appliance housing.

29. The cooking grill of claim 28, further comprising:
a burner unit movement body attached to the burner unit, wherein movement of the burner unit movement body between a first position and a second position causes the burner unit to correspondingly move between the use position and the dump position; and
an actuation device enabler attached to the burner unit movement body, wherein the actuation device enabler causes the actuation device to be in the first state of operability when the burner unit movement body is in the first position and causes the actuation device to be in the second state of operability when the burner unit movement body is moved to a position away from the first position.

30. The cooking grill of claim 29 wherein
when the burner unit is in the use position, a top face of the burner unit faces an opening within a top face of the appliance housing through which the interior space is accessible; and
when the burner unit is in the dump position, the top face of the burner unit faces away from the opening within the top face of the appliance housing.
